(19) United States
(12) Patent Application Publication
(10) Pub. No.: US 2026/0088562 A1
(43) Pub. Date: Mar. 26, 2026

(54) Connector

(71) Applicant: Aptiv Technologies AG, Schaffhausen (CH)

(72) Inventors: Saravanan Balajivenkatesan, Sholinghur (IN); Venkatesan Mahalingam, Gudiyatham taluk (IN); Girivasan Logesh, Ranipet (IN); Kevin S. Turner, Vienna, OH (US)

(21) Appl. No.: 19/038,763

(22) Filed: Jan. 28, 2025

(30) Foreign Application Priority Data
Sep. 26, 2024 (IN) 202441072747

(51) Int. Cl. H01R 13/627

(52) U.S. Cl. CPC H01R 13/6273; H01R 2201/26

(57) ABSTRACT

A connector includes a body portion and a flexible locking arm extending from the body portion. The flexible locking arm includes a stop surface configured to engage a portion of a second connector and releasably secure the second connector to the first connector.

### CROSS-REFERENCE TO RELATED APPLICATIONS

This application claims priority to India App. No. 202441072747 filed Sep. 26, 2024, the entire disclosure of which is incorporated herein by reference.

### FIELD

The present disclosure relates to a connector and more particularly to a connector assembly including the connector.

### BACKGROUND

Modern vehicles (e.g., automobiles) rely on electrical wiring and electrical connections to facilitate communication between various electronic components within the vehicle. Connection systems (e.g., connectors and terminals) play an important role in ensuring the integrity of these electrical connections and the reliability and performance of the vehicle. Some connector assemblies use a connector body with separate and/or external features and/or components (e.g., terminal and/or blade stabilizers) for securing a position of the terminals within the connector. Conventionally, connector assemblies do not include an option to remove the stabilizer from the assembly without using an external tool to deflect a pre-stage retention lock. This makes it difficult to service a connector assembly including a blade stabilizer (e.g., a male blade stabilizer) very difficult. Accordingly, a continuous need for improvement remains in the pertinent art to address the challenges associated with robust assembly of connector assemblies.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

A connector includes a body portion and a flexible locking arm extending from the body portion. The flexible locking arm includes a stop surface configured to engage a portion of a second connector and releasably secure the second connector to the first connector.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The present disclosure will become more fully understood from the detailed description and the accompanying drawings.

FIG. 1 is an exploded view of an example connector assembly according to the principles of the present disclosure.

FIG. 2 is a perspective view of the connector assembly of FIG. 1 in an assembled configuration, a portion of the connector assembly being hidden for clarity.

FIG. 3 is a perspective view of an example connector of a connector assembly according to the principles of the present disclosure.

FIG. 4 is a cross-sectional view of the connector of FIG. 3 taken along the line 4-4 of FIG. 3.

FIG. 5 is a perspective view of an additional example connector of a connector assembly according to the principles of the present disclosure.

FIG. 6 is a top view of the additional connector of FIG. 5.

FIG. 7 is a front view of the connector assembly of FIG. 1 in an assembled configuration.

FIG. 8 is a cross-sectional view of the connector assembly of FIG. 2 taken along the line 8-8 of FIG. 2 in a pre-staged position, a portion of the connector assembly being removed for clarity.

FIG. 9 is a cross-sectional view of the connector assembly of FIG. 2 taken along the line 9-9 of FIG. 2 in a staged position, a portion of the connector assembly being removed for clarity.

In the drawings, reference numbers may be reused to identify similar and/or identical elements.

### DETAILED DESCRIPTION

In various implementations, a blade stabilizer arrangement includes features to aid removal of the blade stabilizer (e.g., a male blade stabilizer, “MBS”) from a male connector assembly without using any special tools. The blade stabilizer and lock arms disposed on an associated connector (e.g., a male inner connector) are provided with features for engagement and disengagement. During insertion of the blade stabilizer into the associated connector, features on the blade stabilizer engage with the lock arms on the connector. The features on the blade stabilizer release the arms and allow the blade stabilizer to be inserted. A stop then limits the movement of the blade stabilizer into the connector assembly. In this position, the lock arms close behind the release features on the blade stabilizer and the blade stabilizer is retained in the connector assembly.

In various implementations, during connection of the connector to a corresponding other connector (e.g., a female connector), features on the other connector release the lock arms and allow the blade stabilizer to move into the final stage position in the male connector assembly. During disengagement of the connector from the other connector, features on the other connector (e.g., female inner connector) pull the blade stabilizer back to pre-stage position. The features on the connector (e.g., male inner connector) lock arms and features (e.g., tear drop features) on the blade stabilizer limit movement of the blade stabilizer to the pre-stage position and retain the blade stabilizer in the connector assembly (e.g., male connector assembly). To remove the blade stabilizer from the connector assembly, a tool can be inserted between the lock arms on each side of the connector, deflecting the lock arms and allowing the blade stabilizer to be removed from the male connector assembly.

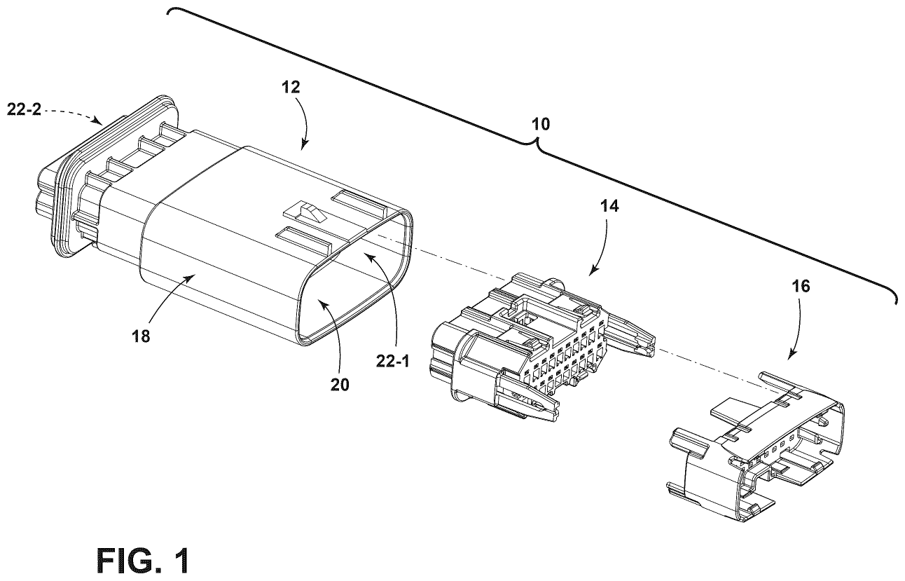

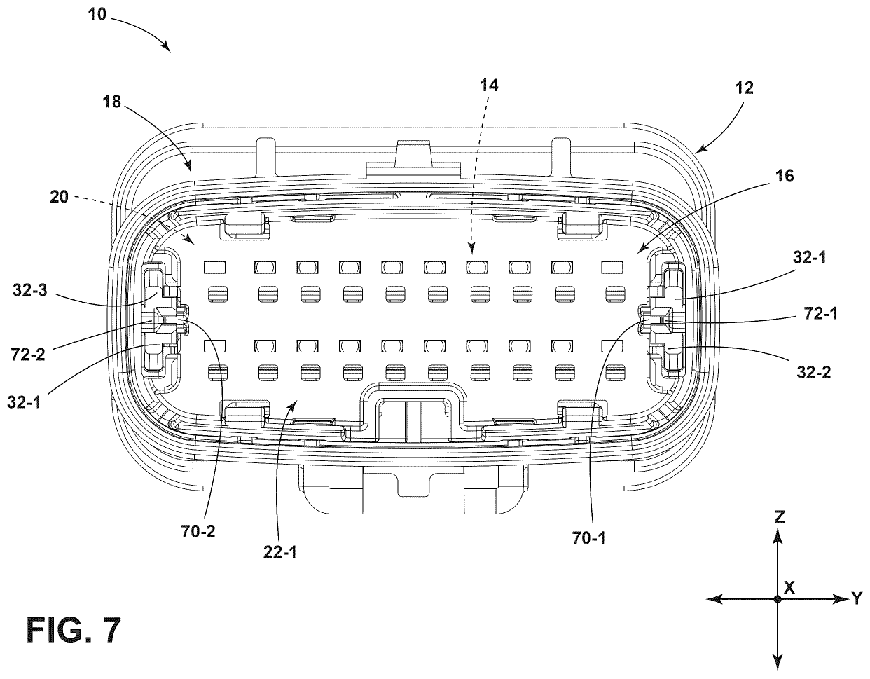

With reference to FIGS. 1, 2, and 7, an example connector assembly 10 is shown. As will be explained in more detail below, the connector assembly 10 may be installed in a vehicle (e.g., an automobile) to facilitate the transmission of electricity between various electronic components within the vehicle. For example, the connector assembly 10 may be a male connector detachably coupled to a mating connector (e.g., a female connector, not shown) such that, during operation, of the vehicle, electricity is transmitted between the connector assemblies and to various electronic components within the vehicle.

In various implementations, the connector assembly 10 includes a housing 12, a first connector 14, and a second connector 16, among others. The housing 12 may comprise one or more of a variety of shapes, sizes, configurations, and/or materials. In various implementations, the housing 12 includes a plurality of walls 18 that define a cavity 20, a first opening 22-1, and a second opening 22-2. The cavity 20 may be in communication with the first opening 22-1 and the second opening 22-2. In various implementations, the first connector 14, the second connector 16, and/or at least portions of a plurality of terminal assemblies (not shown) are removably-disposed in the cavity 20.

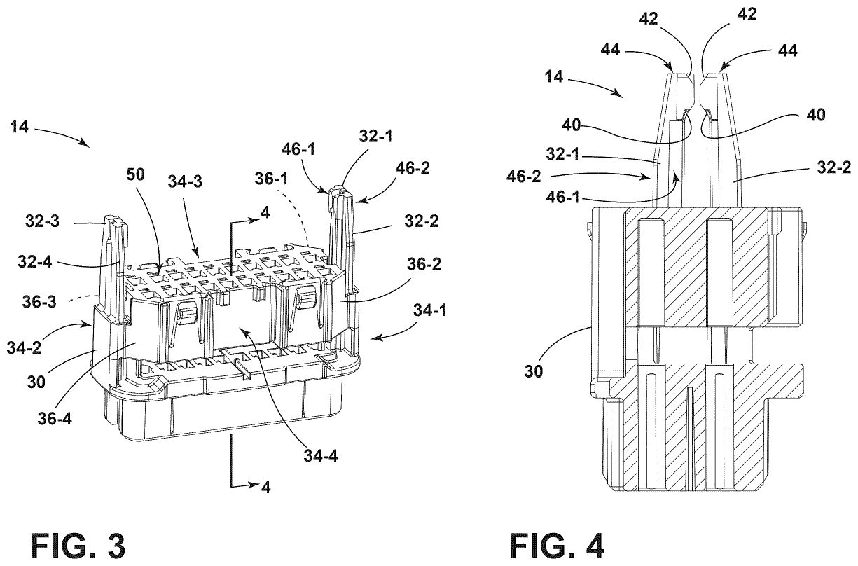

With reference to FIGS. 3 and 4, an example first connector 14 (e.g., a male inner connector, among others) is shown. The first connector 14 may be removably-coupled to the housing 12 and/or the second connector 16. The first connector 14 may comprise one or more of a variety of shapes, sizes, configurations, and/or materials. In various implementations, the first connector 14 includes a body portion 30, a first flexible locking arm 32-1, a second flexible locking arm 32-2, a third flexible locking arm 32-3, and a fourth flexible locking arm 32-4, among others. In various implementations, the locking arms 32-1, 32-2, 32-3, 32-4 extend from the body portion 30.

In some example configurations, the body portion 30 includes a first side 34-1, a second side 34-2 opposite the first side 34-1, a third side 34-3 extending between the first and second sides 34-1, 34-2, and a fourth side 34-4 opposite the third side 34-3. The first and second locking arms 32-1, 32-2 may extend from the first side 34-1 and the third and fourth locking arms 32-3, 32-4 may extend from the second side 34-2. The second locking arm 32-2 may be disposed adjacent to the first locking arm 32-1 and the fourth locking arm 32-4 may be disposed adjacent to the third locking arm 32-3. While the first connector 14 is generally depicted and described herein as including four flexible arms 32, the first connector 14 may include more or less than four flexible arms 32 within the scope of the present disclosure.

In various implementations, the body portion 30 includes a first guide portion 36-1, a second guide portion 36-2, a third guide portion 36-3, and a fourth guide portion 36-4. The first guide portion 36-1 may be disposed adjacent to the first and third sides 34-1, 34-3. The second guide portion 36-2 may be disposed adjacent to the first and fourth sides 34-1, 34-4. The third guide portion 36-3 may be disposed adjacent to the second and third sides 34-2, 34-3. The fourth guide portion 36-4 may be disposed adjacent to the second and fourth sides 34-2, 34-4.

In various implementations, the guide portions 36-1, 36-2, 36-3, 36-4 align the second connector 16 to the first connector 14 during assembly of the connector assembly 10. In various implementations, the guide portions 36-1, 36-2, 36-3, 36-4 do not include locking features. While the body portion 30 is generally depicted and described herein as include four guide portions 36, the body portion 30 may include more or less than four guide portions 36 within the scope of the present disclosure.

In various implementations, each of the locking arms 32-1, 32-2, 32-3, 32-4 includes a stop surface 40 and a staging surface 42. The stop surface 40 may be disposed proximate a terminal end 44 of the locking arm. The staging surface 42 may be disposed proximate the terminal end 44. The staging surface 42 may be disposed between the stop surface 40 and the terminal end 44.

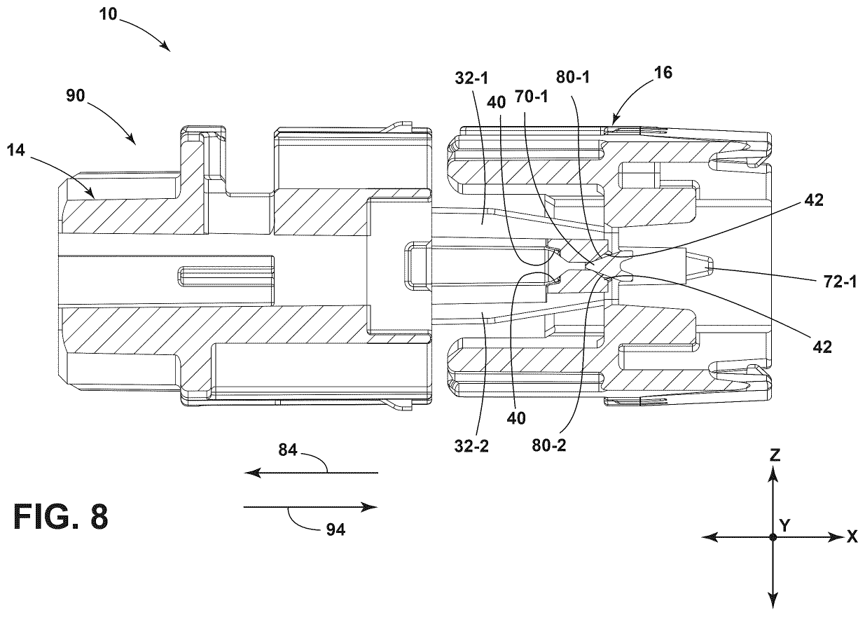

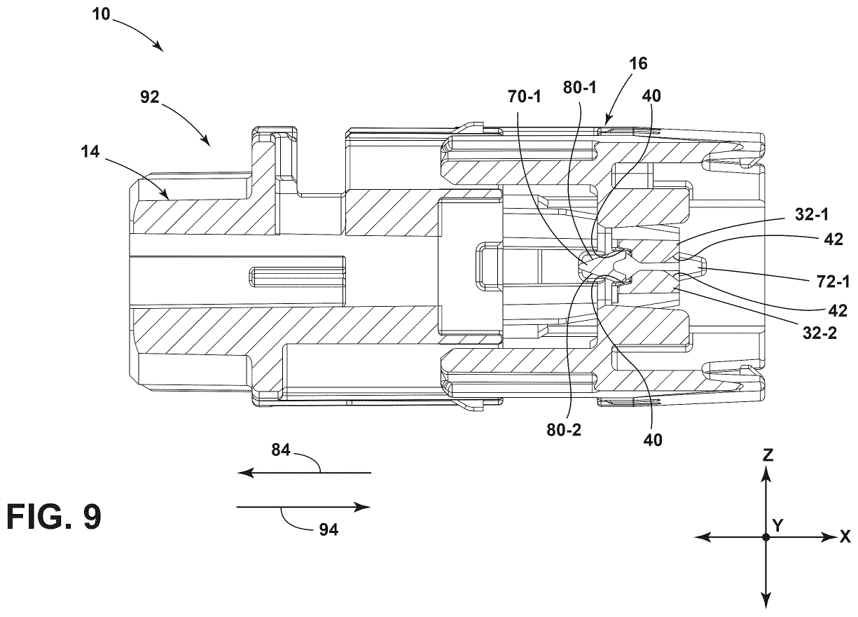

In various implementations, each of the locking arms 32-1, 32-2, 32-3, 32-4 includes an inner side 46-1 and an outer side 46-2 opposite the inner side 46-1. The stop surface 40 may be disposed on the inner side 46-1. As will be explained in further details below, the stop surface 40 engages a portion of the second connector 16 to releasably secure the second connector 16 to the first connector 14 (see, e.g., FIG. 9). The staging surface 42 secures the first connector 14 in a pre-staged position relative to the second connector 16 (see, e.g., FIG. 8).

In various implementations, the body portion 30 defines a plurality of first channels 50. At least one of the channels 50 may receive at least a portion of a terminal assembly (not shown).

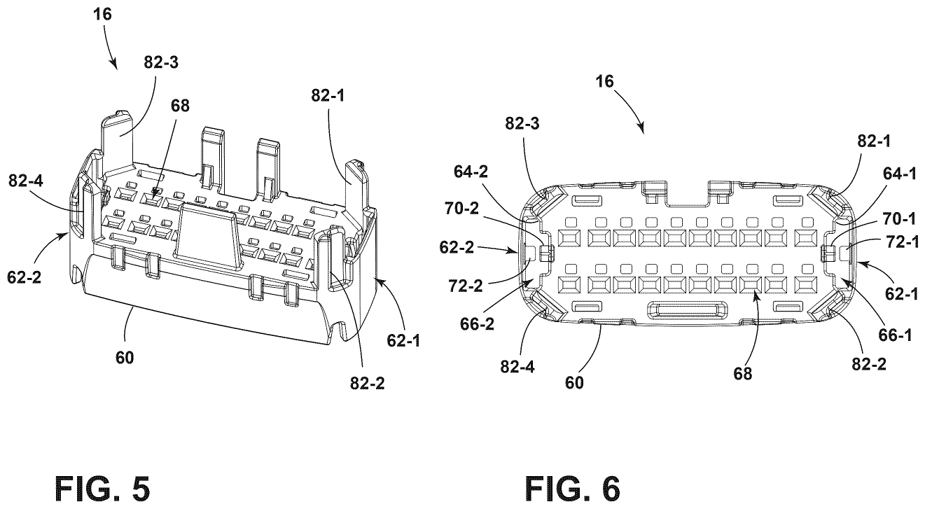

With reference to FIGS. 5 and 6, an example second connector 16 (e.g., a male blade stabilizer, among others) is shown. The second connector 16 may be removably-coupled to the housing 12 and/or the first connector 14. The second connector 16 may comprise one or more of a variety of shapes, sizes, configurations, and/or materials. In various implementations, the second connector 16 includes a body 60 having a first side 62-1 and a second side 62-2 opposite the first side 62-1. The body 60 may include a first inner surface 64-1 and a second inner surface 64-2. The first inner surface 64-1 may define a first aperture 66-1 and the second inner surface 64-2 may define a second aperture 66-2. The first aperture 66-1 may be disposed proximate the first side 62-1 and the second aperture 66-2 may be disposed proximate the second side 62-2. The first aperture 66-1 may receive the first and second locking arms 32-1, 32-2 and the second aperture 66-2 may receive the third and fourth locking arms 32-3, 32-4.

In various implementations, the body 60 defines a plurality of second channels 68. At least one of the channels 68 may receive at least a portion of a terminal assembly (not shown).

In various implementations, the body 60 defines a first projection 70-1, a second projection 70-2, a first protrusion 72-1, and a second protrusion 72-2. The first projection 70-1 and the first protrusion 72-1 may extend from the first inner surface 64-1. The second projection 70-2 and the second protrusion 72-2 may extend from the second inner surface 64-2. The first projection 70-1 and the first protrusion 72-1 may be disposed within the first aperture 66-1. The first protrusion 72-1 may be disposed opposite the first protrusion 72-1. The second projection 70-2 and the second protrusion 72-2 may be disposed within the second aperture 66-2. The second protrusion 72-2 may be disposed opposite the second protrusion 72-2.

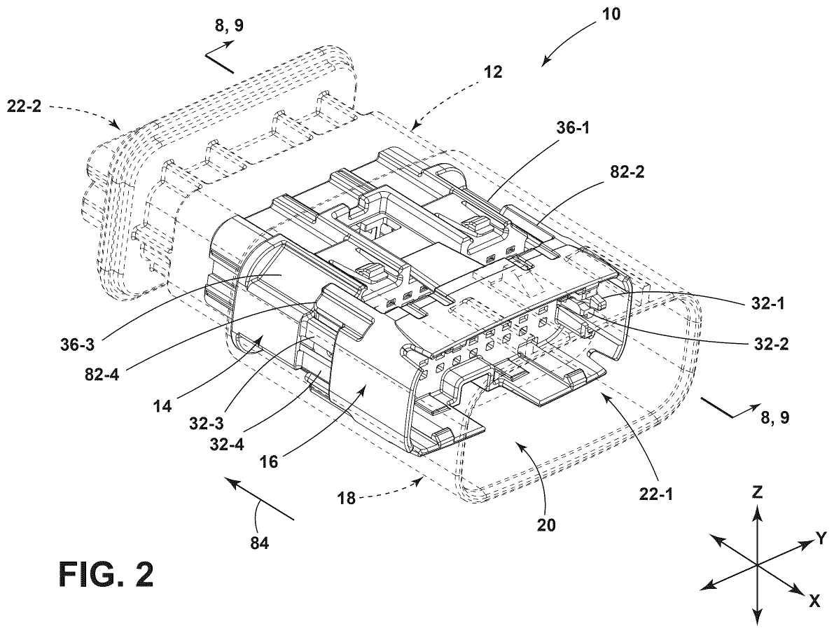

In some example configurations, each of the first and second projections 70-1, 70-2 includes a first portion 80-1 and a second portion 80-2 (see, e.g., FIGS. 8 and 9). In various implementations, the second connector 16 includes a first extension 82-1, a second extension 82-2, a third extension 82-3, and a fourth extension 82-4 that extend from the body 60. Each of the extensions 82-1, 82-2, 82-3, 82-4 engages a corresponding guide portion 36-1, 36-2, 36-3, 36-4 of the first connector 14 to align the second connector 16 to the first connector 14 during assembly of the connector assembly 10 (see, e.g., FIG. 2).

Referring now to FIG. 2, in various implementations, the first and second connectors 14, 16 are inserted into and moved within the cavity 20 during the assembly of the connector assembly 10 (e.g., by a user, a machine, a tool, a robot, among others). The first and second connectors 14, 16 may move within the cavity 20 in a first direction 84 (e.g., X-direction). As will be explained in additional details below, the first connector 14 and/or the second connector 16 may be moved to a pre-staged position 90. Subsequently, the first connector 14 and/or the second connector 16 may be moved to a staged position 92 (e.g., a final position).

With reference to FIG. 8, the connector assembly 10 is shown in a pre-staged position 90. In the pre-staged position 90, each of the locking arms 32-1, 32-2, 32-3, 32-4 of the first connector 14 may engage a projection 70-1, 70-2 of the second connector 14 to constrain movement of the first connector 14 relative to the second connector 16 in a second direction 94 opposite the first direction 84. In various implementations, the staging surfaces 42 of the locking arms 32-1, 32-2, 32-3, 32-4 engage a projection 70-1, 70-2. In some example configurations, a staging surface 42 of a locking arm (e.g., the first locking arm 32-1) engages a first portion 80-1 of a projection (e.g., the first projection 70-1) and a staging surface 42 of an additional locking arm (e.g., the second locking arm 32-2) engages a second portion 80-2 of the projection.

While in the pre-staged position, the connector assembly 10 may be connected to the mating connector. During connection to the mating connector, the mating connector may engage the second connector 16 and move (e.g., in the first direction 84) the second connector 16 such that the connector assembly 10 is in the staged position.

With reference to FIG. 9, the connector assembly 10 is shown in the staged position 92 (e.g., a final position). In the staged position 92, each of the locking arms 32-1, 32-2, 32-3, 32-4 may engage a projection 70-1, 70-2 and a protrusion 72-1, 72-2 of the second connector 14 to constrain movement of the first connector 14 relative to the second connector 16 in the first direction 84 and the second direction 94. For example, the stop surfaces 40 of the locking arms 32-1, 32-2, 32-3, 32-4 engage a projection 70-1, 70-2 to constrain movement of the first connector 14 in the first direction 84. The staging surfaces 42 of the locking arms 32-1, 32-2, 32-3, 32-4 engage a protrusion 72-1, 72-2 to constrain movement of the first connector 14 in the second direction 94.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set-in other words, in some circumstances a “set” may have zero elements. The term “non-empty set” may be used to indicate exclusion of the empty set-in other words, a non-empty set will always have one or more elements. The term “subset” does not necessarily require a proper subset. In other words, a “subset” of a first set may be coextensive with (equal to) the first set. Further, the term “subset” does not necessarily exclude the empty set-in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

Various example embodiments of the invention are described in the following clauses.

Clause 1: A first connector comprising: a body portion; and a flexible locking arm extending from the body portion, the flexible locking arm including a stop surface configured to engage a portion of a second connector and releasably secure the second connector to the first connector.

Clause 2: An electrical connector assembly comprising: the first connector of clause 1; the second connector; and a housing defining a cavity configured to receive the first connector and the second connector, wherein the locking arm is configured to (i) constrain movement of the first connector relative to the second connector in a first direction and (ii) constrain movement of the first connector relative to the second connector in a second direction opposite the first direction.

Clause 3: The electrical connector assembly of clause 2, wherein the stop surface is configured to engage the second connector to constrain movement of the first connector relative to the second connector in the first direction, and wherein the locking arm includes a staging surface disposed between the stop surface and a terminal end of the locking arm and configured to constrain movement of the first connector relative to the second connector in the second direction.

Clause 4: The electrical connector assembly of clause 2 or clause 3, wherein the second connector includes a body that has an inner surface, and wherein the inner surface defines an aperture that is configured to receive the flexible locking arm.

Clause 5: The electrical connector assembly of clause 4, wherein the second connector includes a projection that extends from the inner surface, and wherein the projection is disposed within the aperture.

Clause 6: The electrical connector assembly of clause 5, wherein the locking arm includes a staging surface configured to engage the projection when the first connector is in a pre-staged position.

Clause 7: The electrical connector assembly of clause 5 or clause 6, wherein the stop surface engages the projection when the first connector is in a staged position.

Clause 8: The electrical connector assembly of any of clauses 5 through 7, wherein: the first connector includes an additional flexible locking arm disposed adjacent to the flexible locking arm, the projection includes a first portion and a second portion, and the flexible locking arm is configured to engage the first portion and the additional flexible locking arm is configured to engage the second portion.

Clause 9: The electrical connector assembly of any of clauses 5 through 8, wherein the second connector includes a protrusion disposed within the aperture opposite the projection.

Clause 10: The electrical connector assembly of clause 9, wherein, in a staged position, a staging surface of the first connector engages the protrusion and the stop surface engages the projection.

Clause 11: The electrical connector assembly of any of clauses 4 through 10, wherein the body of the second connector includes an additional inner surface, and wherein the additional inner surface defines an additional aperture that is configured to receive an additional flexible locking arm of the first connector.

Clause 12: The electrical connector assembly of any of clauses 2 through 11, wherein the second connector includes an extension extending from the body portion, and wherein the extension engages a guide portion of the first connector to align the second connector to the first connector.

Clause 13: The first connector of any of clauses 1 through 12, wherein the stop surface is disposed proximate a terminal end of the locking arm.

Clause 14: The first connector of any of clauses 1 through 13, wherein the locking arm includes a staging surface disposed proximate a terminal end of the locking arm and configured to secure the first connector in a pre-staged position relative to the second connector.

Clause 15: The first connector of clause 14, wherein the staging surface is disposed between the stop surface and the terminal end.

Clause 16: The first connector of any of clauses 1 through 15, wherein: the locking arm includes an inner side and an outer side opposite the inner side, and the stop surface is disposed on the inner side.

Clause 17: The first connector of any of clauses 1 through 16, further comprising an additional flexible locking arm extending from the body portion and disposed adjacent to the flexible locking arm.

Clause 18: The first connector of clause 17, wherein the additional flexible locking arm includes an additional stop surface configured to engage an additional portion of the second connector.

Clause 19: The first connector of any of clauses 1 through 18, further comprising an additional flexible locking arm extending from the body portion, wherein the body portion includes a first side and a second side opposite the first side, and wherein the flexible locking arm extends from the first side and the additional flexible locking arm extends from the second side.

Clause 20: The first connector of any of clauses 1 through 19, wherein the body portion includes a guide portion configured to align the first connector to the second connector, and wherein the guide portion does not include a locking feature.

1. A first connector comprising:
a body portion; and
a flexible locking arm extending from the body portion, the flexible locking arm including a stop surface configured to engage a portion of a second connector and releasably secure the second connector to the first connector.

2. An electrical connector assembly comprising:
the first connector of claim 1;
the second connector; and
a housing defining a cavity configured to receive the first connector and the second connector, wherein the locking arm is configured to (i) constrain movement of the first connector relative to the second connector in a first direction and (ii) constrain movement of the first connector relative to the second connector in a second direction opposite the first direction.

3. The electrical connector assembly of claim 2, wherein the stop surface is configured to engage the second connector to constrain movement of the first connector relative to the second connector in the first direction, and wherein the locking arm includes a staging surface disposed between the stop surface and a terminal end of the locking arm and configured to constrain movement of the first connector relative to the second connector in the second direction.

4. The electrical connector assembly of claim 2, wherein the second connector includes a body that has an inner surface, and wherein the inner surface defines an aperture that is configured to receive the flexible locking arm.

5. The electrical connector assembly of claim 4, wherein the second connector includes a projection that extends from the inner surface, and wherein the projection is disposed within the aperture.

6. The electrical connector assembly of claim 5, wherein the locking arm includes a staging surface configured to engage the projection when the first connector is in a pre-staged position.

7. The electrical connector assembly of claim 5, wherein the stop surface engages the projection when the first connector is in a staged position.

8. The electrical connector assembly of claim 5, wherein:
the first connector includes an additional flexible locking arm disposed adjacent to the flexible locking arm,
the projection includes a first portion and a second portion, and
the flexible locking arm is configured to engage the first portion and the additional flexible locking arm is configured to engage the second portion.

9. The electrical connector assembly of claim 5, wherein the second connector includes a protrusion disposed within the aperture opposite the projection.

10. The electrical connector assembly of claim 9, wherein, in a staged position, a staging surface of the first connector engages the protrusion and the stop surface engages the projection.

11. The electrical connector assembly of claim 4, wherein the body of the second connector includes an additional inner surface, and wherein the additional inner surface defines an additional aperture that is configured to receive an additional flexible locking arm of the first connector.

12. The electrical connector assembly of claim 2, wherein the second connector includes an extension extending from the body portion, and wherein the extension engages a guide portion of the first connector to align the second connector to the first connector.

13. The first connector of claim 1, wherein the stop surface is disposed proximate a terminal end of the locking arm.

14. The first connector of claim 1, wherein the locking arm includes a staging surface disposed proximate a terminal end of the locking arm and configured to secure the first connector in a pre-staged position relative to the second connector.

15. The first connector of claim 14, wherein the staging surface is disposed between the stop surface and the terminal end.

16. The first connector of claim 1, wherein:
the locking arm includes an inner side and an outer side opposite the inner side, and
the stop surface is disposed on the inner side.

17. The first connector of claim 1, further comprising an additional flexible locking arm extending from the body portion and disposed adjacent to the flexible locking arm.

18. The first connector of claim 17, wherein the additional flexible locking arm includes an additional stop surface configured to engage an additional portion of the second connector.

19. The first connector of claim 1, further comprising an additional flexible locking arm extending from the body portion,
wherein the body portion includes a first side and a second side opposite the first side, and
wherein the flexible locking arm extends from the first side and the additional flexible locking arm extends from the second side.

20. The first connector of claim 1,
wherein the body portion includes a guide portion configured to align the first connector to the second connector, and
wherein the guide portion does not include a locking feature.
